(19) United States
(12) Patent Application Publication
(10) Pub. No.: US 2014/0089321 A1
(43) Pub. Date: Mar. 27, 2014

(54) METHOD AND SYSTEM TO RECOMMEND RECIPES

(71) Applicant: Cozi Group Inc., Seattle, WA (US)

(72) Inventors: Lawrence ENGEL, Seattle, WA (US); Kati CHEVAUX, Seattle, WA (US)

(21) Appl. No.: 13/629,031

(22) Filed: Sep. 27, 2012

(51) Int. Cl. G06F 17/30

(52) U.S. Cl. 707/748; 707/E17.009

(57) ABSTRACT

Disclosed is a recipe recommendation system and method which builds and maintains user and recipe profiles, which matches user and recipe profiles to recommend recipes, which changes recommended recipes based on season and other factors, which adjusts user profiles based on explicit and implicit feedback, which integrates mobile computing and grocery delivery services, and which offers a complete service.

### BACKGROUND INFORMATION

Planning meals and purchasing groceries can be a significant chore and source of stress for individuals, families, and family members. Members of a family may communicate regarding what meals to consider preparing in an day or week or the choice may be left to one family member, the family (or family member) may select a set of meals for the day or week, find recipes for these meals, review what items are already on hand and what items are needed, itemize a grocery list, go to the grocery store, purchase the items, bring the items home and prepare the meal or meals.

As determined by surveys and as informed by experience, one of the largest sources of stress in the foregoing is selecting what meals to prepare in a day or week. Many of the remaining tasks require time and effort, but do not involve the same decision making process as the initial step.

Many services exist which allow users to search for recipes in an electronic context, such as on a website. Recipes found with such services can be added to recipe collections, recipes in recipe collections can be organized by the user, and shopping lists can be generated corresponding to recipes. While this facilitates finding recipes and preparing shopping lists, this does not address the stress of determining a meal plan for an oncoming day or week and having to search and choose among hundreds or even thousands of recipes only exacerbates the problem of selecting a meal plan for a day or week.

Fewer services exist which recommend a set of recipes to users. For example, EMEALS™ by E-mealz, Inc., allows subscribing users to sign up to receive, via email, recipes and shopping lists for specific stores. Subscribers can sign up for menus, such as “Clean Eating,” “Gluten Free,” “Low Carb,” “Low Fat,” “Portion Control,” “Vegetarian,” and “Natural & Organic.”

While a step toward addressing the unmet need of selecting what meals to prepare, services such as EMEALS do not utilize or adjust an algorithm to determine what recipes to recommend to specific users, based on the users' preferences. Subscribers select the type of menu they would like to receive, meal plans corresponding to the menus are selected by editors, and the meal plans are emailed to subscribers. If a meal plan is not appealing, the user must select a different meal plan and see how it goes. The meal plans are not tailor made to the user. There is no attempt to build and maintain complex user and multi-user (family) profiles (collectively referred to herein as a “user profile”), to build and maintain recipe profiles, to programmatically match user and recipe profiles, to change recommendations programmatically based on season and locally available products, there is no longitudinal fine-tuning of user profiles over time based on explicit and implicit user feedback, mobile computing technology and grocery delivery services are not integrated with the overall process, and a complete service is not offered to ease the stress of meal planning and to then facilitate the remaining steps relating to grocery shopping.

Needed is a system which addresses the shortcomings discussed above.

### SUMMARY

Disclosed is a recipe recommendation system and method which builds and maintains user and recipe profiles, which matches user and recipe profiles to recommend recipes, which changes recommended recipes based on season and other factors, which adjusts user profiles based on explicit and implicit feedback, which integrates mobile computing and grocery delivery services, and which offers a complete service.

### BRIEF DESCRIPTION OF THE DRAWINGS

FIG. 1 is a network and device diagram illustrating exemplary computing devices configured according to embodiments disclosed in this paper.

FIG. 2 is a flowchart illustrating an overview of a process to recommend recipes and manage user profiles according to embodiments disclosed in this paper.

FIG. 3 is a flowchart illustrating a detail of a process which may be included in the process illustrated in FIG. 2, in which a set of recipes are filtered.

FIG. 4 is a flowchart illustrating a detail of a process which may be included in the process illustrated in FIG. 2, in which a set of recipes are ranked.

FIG. 5 is a flowchart illustrating a process which may be included in the process illustrated in FIG. 2, in which selections are made among a set of ranked recipes.

FIG. 6 is a flowchart illustrating a process which may be included in the process illustrated in FIG. 2, in which selected recipes are communicated to users.

FIG. 7 is a flowchart illustrating a process which may be included in the process illustrated in FIG. 2, in which user input is received and processed.

FIG. 8 is a functional block diagram of exemplary computing devices and some data structures and/or components thereof.

FIG. 9 is a table discussed in relation to FIG. 4 (and discussed below).

### DETAILED DESCRIPTION

The following description provides specific details for an understanding of various examples of the technology. One skilled in the art will understand that the technology may be practiced without many of these details. In some instances, structures and functions have not been shown or described in detail or at all to avoid unnecessarily obscuring the description of the examples of the technology. It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect between two or more elements; the coupling of connection between the elements can be physical, logical, or a combination thereof. Additionally, the words, “herein,” “above,” “below,” and words of similar import, when used in this application, shall refer to this application as a whole and not to particular portions of this application. When the context permits, words using the singular may also include the plural while words using the plural may also include the singular. The word “or,” in reference to a list of two or more items, covers all of the following interpretations of the word: any of the items in the list, all of the items in the list, and any combination of one or more of the items in the list.

As used herein, “vegetarian” means a meal which is prepared without the use of meat, fish, or shellfish, but which may include dairy products (such as cheese and eggs).

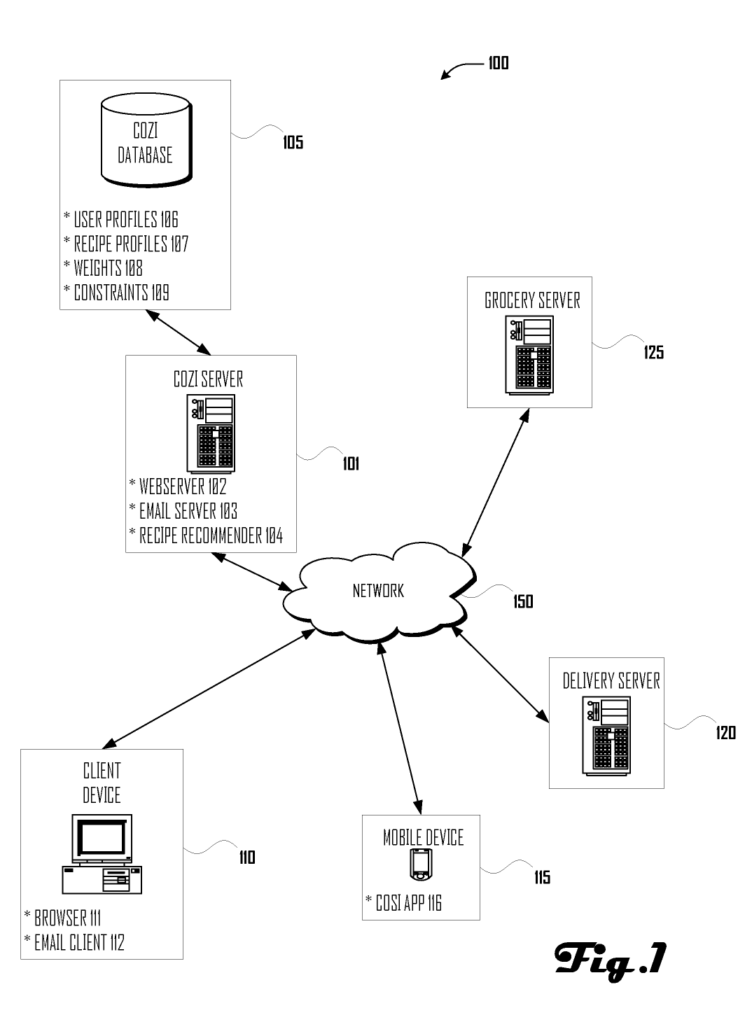

FIG. 1 is a network and device diagram illustrating exemplary computing devices configured according to embodiments disclosed in this paper. In FIG. 1, a Cozi Server 101 is connected to a Network 150, such as the Internet; the Cozi Server 101 is illustrated as being connected to a Cozi Database 105. This paper discusses components as connecting to the Cozi Server 101 or to the Cozi Database 105; it should be understood that such connections may be to, through, or via the other of the two connected components (for example, a statement that a computing device connects with or sends data to the Cozi Server 101 should be understood as saying that the computing device may connect with or send data to the Cozi Server 101 and/or the Cozi Database 105). Although illustrated as separate components, the servers and databases may be provided by common (or separate) physical hardware and common (or separate) logic processors and memory components.

The Cozi Server 101 may maintain a database, such as the Cozi Database 105, containing user profiles 116, recipe profiles 107, weights 108, and constraints 109. User profiles 116 and recipe profiles 107 may contain records which categorize recipes; such records are referred to herein as “categorization elements.” Categorization elements comprise database entries, objects, or groups of database entries indicating, for example, a main ingredient of a recipe, whether a recipe is vegetarian, a dish type of a recipe, and equipment required to prepare a recipe (also referred to herein as the “equipment categorization element”). The main ingredient categorization element encodes the main ingredient of a recipe and may encode, for example, whether the main ingredient is one of pork, beef, lamb, chicken, turkey, fish, and shellfish. The dish type categorization element encodes what dish type the recipe prepares, such as, for example, a soup (which as used herein should also be understood to include stew), a salad, and a sandwich. The equipment categorization element encodes one or more types of equipment which may be required to prepare a recipe, such as, for example, whether a slow cooker is required to prepare the recipe.

Other categorization elements may be used, such as, for example, a categorization element encoding the time of day when the meal corresponding to the recipe is usually eaten (“breakfast,” “lunch,” “dinner,” etc.), encoding an ethnic or geographic heritage of the recipe (“Americana,” “Italian,” “French,” “Chinese,” “Mexican,” etc.), encoding ingredients of the recipe which produce an allergic reaction or which otherwise are not consumed by a party (“peanuts,” “gluten,” “dairy,” etc.), encoding whether the recipe conforms to religious or dietary requirements (“kosher,” “halal,” “low-fat,” “low-carbohydrate,” etc.), or similar.

The categorization elements may be represented by one or more columns in a database, wherein records in the database may contain a numeric value, a binary value, a logical value (on or off, yes or no), text, or similar. For example, the main ingredient categorization element may comprise multiple columns, for example, one column for each of pork, beef, lamb, chicken, turkey, fish, and shellfish; a zero or “not” value in a record in a column may indicate that the ingredient is not the main ingredient. Alternatively, for example, the main ingredient categorization may contain two columns for each of these ingredients. The first column many contain a binary or logical value indicating whether or not there is a non-zero value in the second column; the second column may then contain a number, including a numeric range. The recipe profiles and user profiles may include different columns for each; for example, while a recipe profile may include a single binary or logical value column for each of the foregoing main ingredients (indicting whether the main ingredient is present or not), a user profile may include two columns, the first with a binary or logical value (indicating whether or not the main ingredient may be included in recipes for the user), the second column containing a number, including a numeric range (indicating the user's affinity for the main ingredient).

The user profile may also contain additional fields, such as, for example, fields identifying recipes as “Keepers,” a caloric threshold which the user does not want recipes to exceed, recipes sent to the user and when, whether a user printed a recipe, whether a user instructed not to dim an interface (such as in the Cozi App 116) displaying a recipe, what recipe, and when, whether a user requested a shopping list, when, and with what recipes, whether a user requested to purchase and/or have groceries delivered, when, and relating to what recipes, and user ratings of recipes. Keepers are recipes which a user wants to save; the user may be presented with an opportunity to add Keepers to a menu plan.

Users of the Cozi Server 101 may be required to create an account with the Cozi Server 101, such as, for example, by providing login credentials (such as username and password). In a database, such as the Cozi Database 105, a user account may be associated with a GUID or other identifier which may be associated with records associated with the user, including the user's login credentials. More than one user, such as members of a family, may be grouped together in one account or account view. This may be performed at the server level, such as by associating different login credentials with one account or account view and/or this may be accomplished by assigning different login identifiers (such as email addresses) with a common password. In addition to login credentials and identifiers, an account may also contain one or more user profiles.

A user profile as discussed herein may be associated with a single user or a group of users. When associated with a group of users, values in the an user profile may be controlled by a single controlling user, with processes provided to allow the non-controlling users to suggest changes, or values in the user profile may be controlled by the last user in the group to access the profile, or values in the user profile may be controlled by a vote process, which vote process may also include weights assigned to different users in the group (such as that parents may have more weight than children). When more than one user is part of a user group, each user's profile may be retained, notwithstanding that the individual user profiles are different from the group profile. When dealing with user profiles encompassing a group of users, the recipe recommendations may be tailored to the user profile representing the group of users or to one or more user profiles with the group. For example, a parent may know that only children will be present for dinner on a particular Friday. The parent may request recipe recommendations for the remainder of the week that are selected according to the user profile for the family, while requesting recipe recommendations for Friday selected according to the user profile(s) for the children.

Users of the Cozi Server 101 may connect to the Cozi Server 101 across the network 150 via or from a client computing device, such as Client Device 110 and Mobile Device 115. All of the client devices may comprise a touchscreen interface in addition to or instead of a display, keyboard, mouse, trackball, stylus, voice and other input and output media. References herein to any of the client devices should be understood to be interchangeable, except where the context indicates otherwise. As shown in FIG. 1, Client Device 110 may comprise a routine for a web browsing application, Browser 111, while Mobile Device 115 comprises a routine for a Cozi App 116. Both the Browser 111 and the Cozi App 116 may provide an interface for interacting with the Cozi Server 101, for example, through the Webserver 102 (which may serve data and information in the form of webpages as well as to the Cozi App 116). Connection to the Cozi Server 101 from a client device may be through the Browser 111 and/or through the Cozi App 116 (which may use a web browsing application as an interface). In addition to as illustrated in FIG. 1, login credentials and local instances of user profiles, such as User Profile 116, may be stored in or be accessible to the client device. The Cozi App 116 may be stored and executed remotely relative to the client device, with the user provided access via application virtualization, such as remote terminal services, and/or, for example, through a web browser. Logging into the client device via the Browser 111 and/or the Cozi App 116 may provide access to the Cozi Server 101 and the recipe recommendation system discussed herein.

FIG. 1 also illustrates a Grocery Server 125 and a Delivery Server 120 as being connected to the Network 150. These servers may be maintained by a grocery store and/or delivery service and/or a third party providing access to such goods and services. These servers may be accessed, for example, to obtain information regarding what groceries are available, to order groceries, to have groceries delivered, and/or to pay for such goods and services.

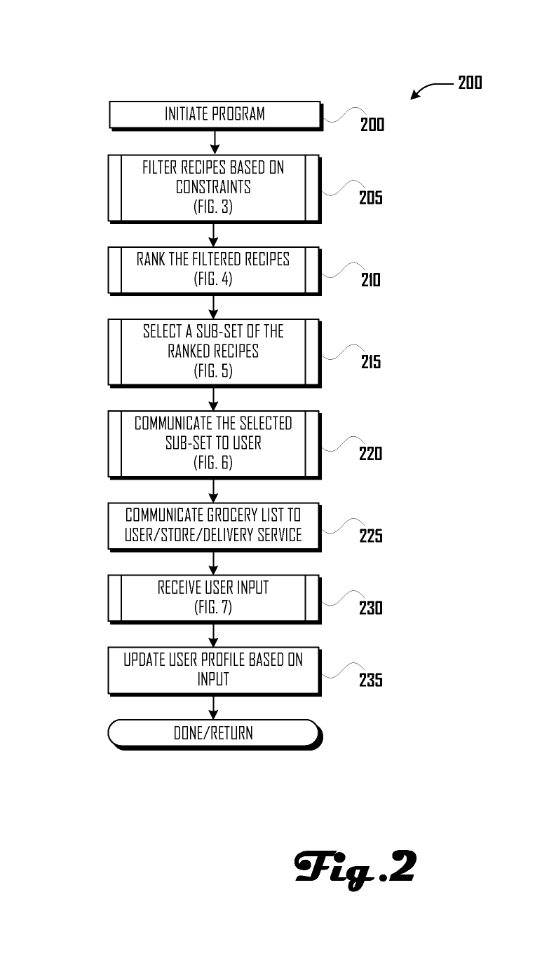

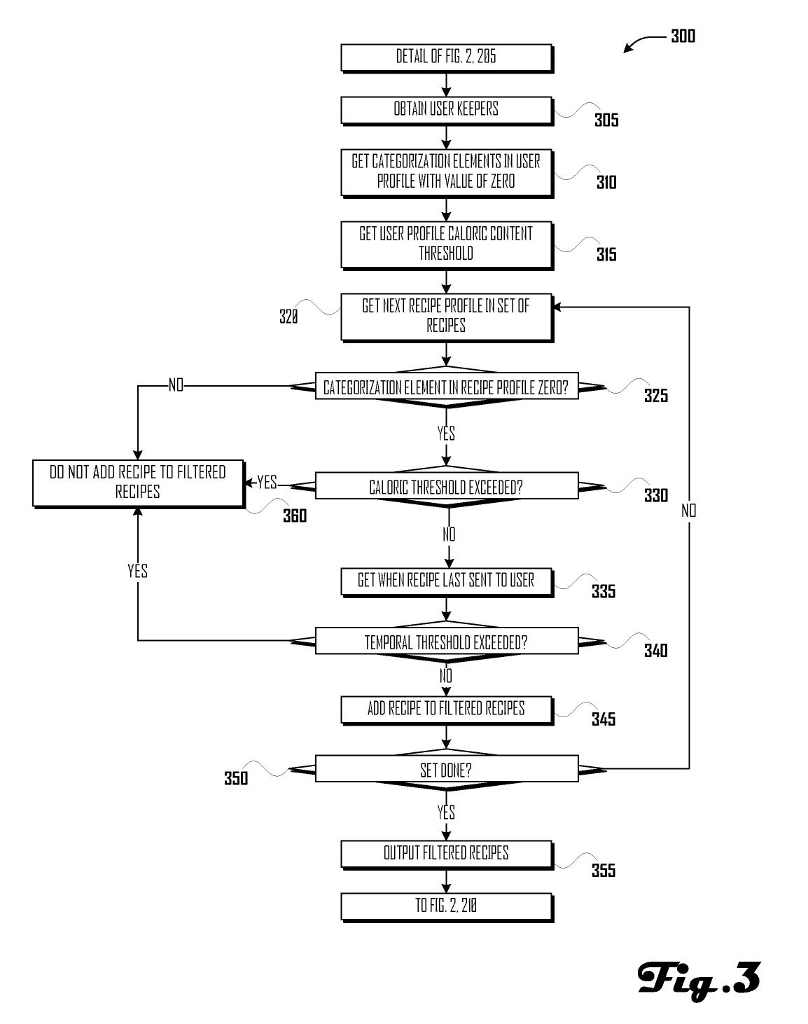

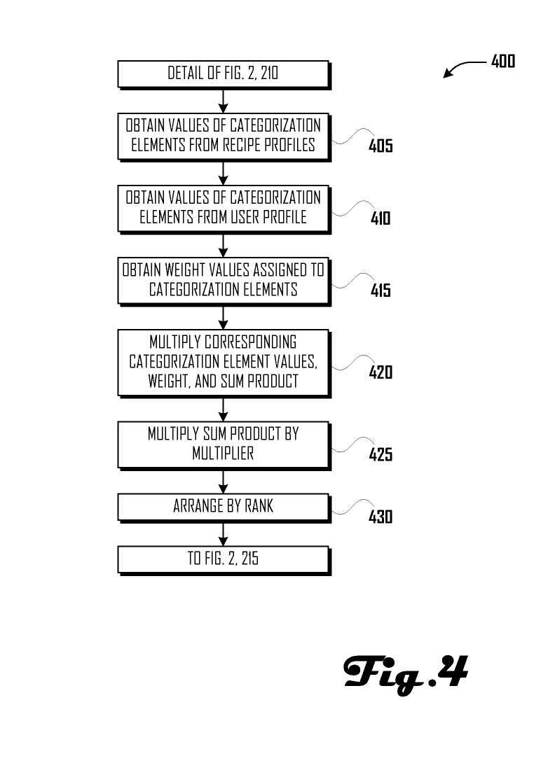

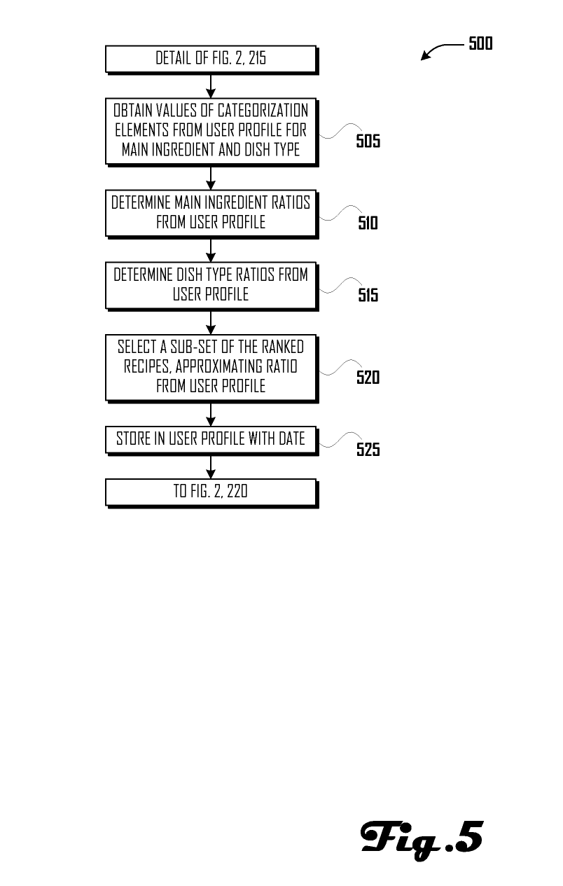

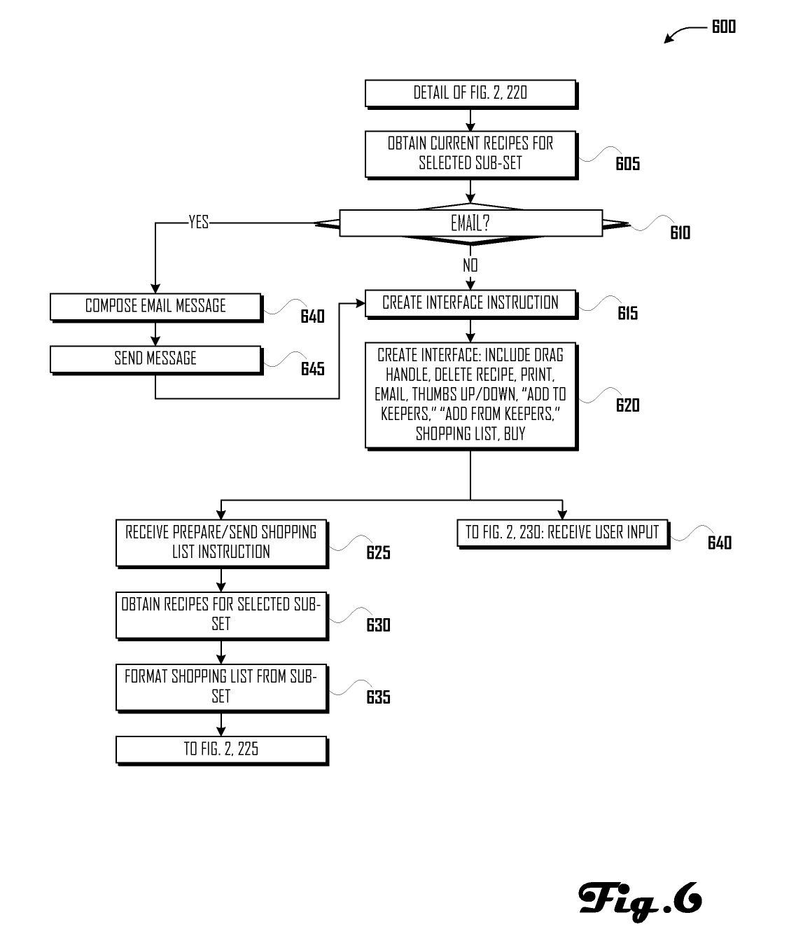

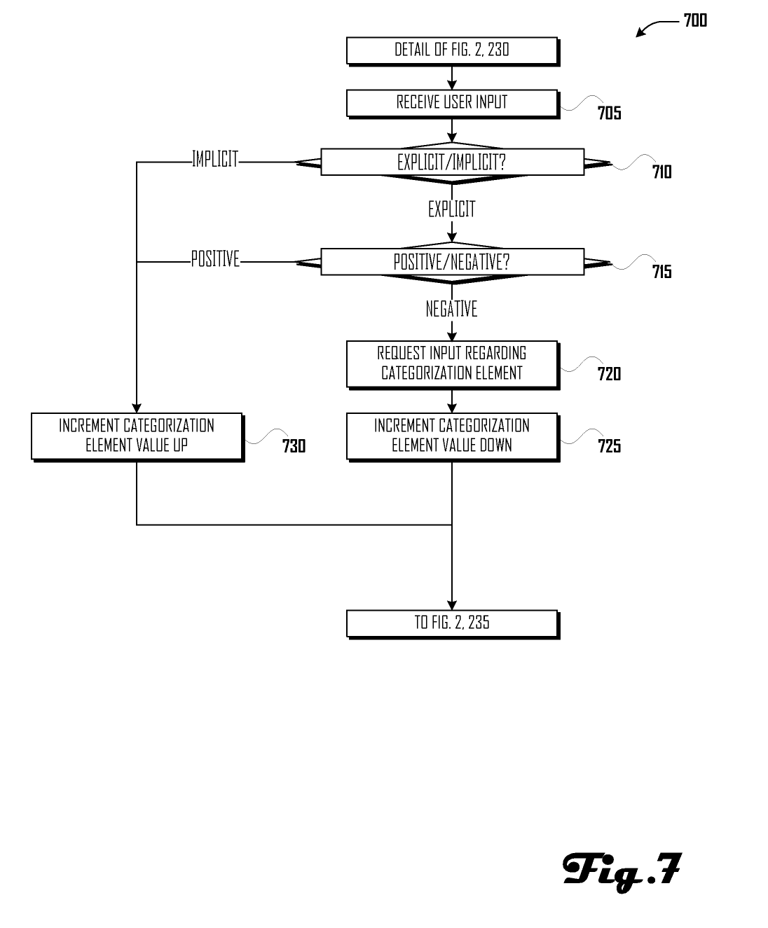

FIG. 2 is a flowchart illustrating an overview of a process to recommend recipes and manage user profiles according to embodiments disclosed in this paper. At step 200, the recipe recommendation routine is initiated, for example on the Cozi Server 101, represented by Recipe Recommender 104 in FIG. 1. As illustrated in FIG. 2, at step 205 the Recipe Recommender 104 may filter recipes based on constraints (with additional detail shown in FIG. 3). At step 210, the filtered recipes may be ranked (with additional detail shown in FIG. 4). At step 215, a sub-set of the ranked recipes may be selected (with additional detail shown in FIG. 5). At step 220, the selected sub-set may be communicated to a user (with additional detail shown in FIG. 6). At step 225, if requested by a user, a grocery list may be communicated to a user, to a grocery store (such as, for example, via Grocery Server 125), and/or to a delivery service (such as, for example, via Delivery Server 120). At step 230, user input may be received (with additional detail shown in FIG. 7). At step 235 the user profile may be updated based on the user input. The process may then be done and/or may return to one or more of the preceding steps.

In the process illustrated in FIG. 2, elements 205 through 215 may be performed once per week by, for example, the Recipe Recommender 104, with the output of step 215 being stored, for example, in the user profiles 106, along with a date or date-time record, which date record may indicate the date when the recommended recipes were stored in the user profile, a date after which the recommended recipes should no longer be accessed, or similar. When proceeding to step 220, the date record may be accessed, or the recommended recipes may be sorted by the date record, to identify recommended recipes which are current and are to be communicated to the user at step 220. This is discussed further below, in relation to FIGS. 5 and 6.

FIG. 3 is a flowchart illustrating a detail of a process which may be included in the process illustrated in FIG. 2, in which a set of recipes are filtered. At step 305, the user's Keepers may be obtained from the user's profile. Keepers may be obtained at this step (and filtered out by the process shown in FIG. 3) to ensure that the Recipe Recommender 104 is recommending new recipes to the user; the user may add Keepers to a recipe list (as discussed below). At step 310, the user profile may be checked to identify if certain categorization elements have a value of zero. As used herein, a value of zero for a categorization element or other database record should be understood to be equivalent to a minimum value, an “off” value, or a “not” value, as may be expressed by a binary or logical database record; in an implementation, a categorization element my comprise more than one database record. For example, a categorization element may comprise both a numeric range from 0 to 9, as well a binary or logical representation, which binary representation may indicate whether there is any non-zero value in the numeric range. For example, the categorization element for main ingredient may be checked to determine if there is a value of zero in relation to beef, lamb, chicken, turkey, fish, or shellfish main ingredients. At step 315, a caloric content threshold may be obtained from the user profile. The caloric content threshold may be a number which encodes a caloric content threshold or it may be a number representing a caloric content threshold. At step 320, the next (which may be the first) recipe profile for a set of recipes is obtained.

At step 325 a determination may be made regarding whether the categorization elements with a value of zero obtained at step 310 also have a zero value in the recipe profile. For example, if the main ingredient categorization element for the user profile at step 310 encodes a value of zero for shellfish, this decision at step 325 will determine if the recipe profile has a value of zero for shellfish (in the corresponding categorization element). If the determination at step 325 was affirmative (that both the user profile and the recipe profile have zero values for specific categorization elements—which may indicate, for example, that the user wants no shellfish and that the recipe contains no shellfish), then at step 330 a determination may be made regarding whether the caloric content threshold from the user profile (obtained at step 315) is exceeded by the calorie count for the recipe. If the determination is negative (that the user's caloric content threshold is not exceeded by the calorie count for the recipe), then the process may proceed to step 335, where the Recipe Recommender 104 may get the date (and time) when the recipe was last sent to the user (which information may be found in, for example, the user profile). At step 340, a determination may be made regarding whether the recipe was sent to and included in a recipe list for the user too recently, such as according to a temporal threshold. If the temporal threshold was not exceeded (if the recipe was not recently in a recipe list for the user), then the process may proceed to step 345, where the recipe is added to the set of filtered recipes. If the determination at step 325 was negative or if the caloric threshold was found to have been exceeded at step 330, or if the temporal threshold was found to have been exceeded at step 340, then at step 360 a step may occur in which the recipe is not added to the set of filtered recipes. Not shown, step 360 may also include storing that the recipe was excluded, for example, as information in the user profile. The Recipe Recommender 104 may also, for example, store and track the number of filtered recipe sets in which different recipes appear.

At step 350 a determination may be made regarding whether the set of all recipes (or at least those being filtered) has concluded. If it has, then the filtered recipe set may be output at step 355. If not, then the process may return to step 320, where the next recipe profile in the set of recipes is obtained and the process continues.

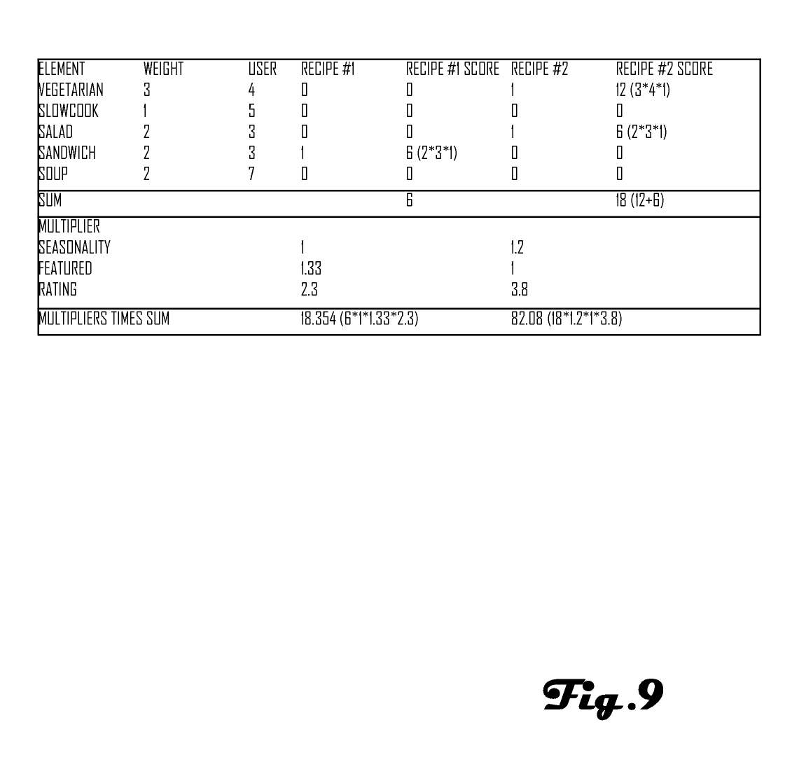

FIG. 4 is a flowchart illustrating a detail of a process which may be included in the process illustrated in FIG. 2, in which a set of recipes are ranked. At step 405, if not already available, the Recipe Recommender 104 obtains the values of some or all categorization elements for the filtered recipes from the recipe profiles. At step 410 the Recipe Recommender 104 obtains the values of the corresponding categorization elements from the user profile. At step 415, the Recipe Recommender 104 optionally obtains global weights for the categorization elements, which global weights may be assigned by operators of the Recipe Recommender 104. At step 420 the Recipe Recommender 104 multiplies the categorization element values from the user profiles by the corresponding categorization element values from the recipe profiles, and, optionally, by the weight and then sums the products thereof. FIG. 9 contains a table demonstrating the foregoing, recipe #1 in FIG. 9 being for a sloppy joe; recipe #2 being for a greek salad. As depicted in FIG. 9 across the row labeled “SUM,” the greek salad returns a higher score (and hence a higher rank) than the sloppy joe for this user (at this stage in the process). At step 425, the sum is multiplied by one or more multipliers, such as multipliers for seasonality, for whether the recipe is featured, and for the rating of the recipe. As illustrated in FIG. 9 across the row labeled “MULTIPLIERS TIMES SUM,” the sloppy joes has a modified score sum of 18.354 while the greek salad has a modified score sum of 82.08. At step 430 the filtered recipes may be arranged by rank (or, somewhat equivalently, the rank recorded for the filtered recipes may be recorded, with optional sorting or search by rank).

FIG. 5 is a flowchart illustrating a process which may be included in the process illustrated in FIG. 2, in which selections are made among a set of ranked recipes. At optional step 505, the Recipe Recommender 104 obtains the values of categorization elements from the user profile for the main ingredient and/or the dish type. At optional steps 510 and 515, the ratio of different options within these categorization elements may be determined, for example, the ratio of fish to chicken to beef or the ratio of soup to salad to sandwich. One of steps 510 or 515 may be omitted if only one of main ingredient or dish type was used at step 505. At step 520, a sub-set of the ranked recipes may be selected. If optional steps 505, 510, and 515 were performed, the sub-set selection may be selected according to the approximate the ratio(s) determined relative to the user profile.

For example, if a user profile has a ratio among main ingredient categorization elements approximating 1:0:0:2:1:1:1 (for pork, beef, lamb, chicken, turkey, fish, and shellfish), and if the first three most highly ranked recipes have pork as a main ingredient, then the first of the three highly ranked pork recipes may be selected while the next two pork recipes may be skipped; if the next two highly ranked recipes (after the pork recipes) are shellfish recipes (with shellfish as the main ingredient), then one of the two shellfish recipes may be selected; if the next highly ranked recipe is a chicken recipe, then it may be selected (leaving one additional chicken recipe which may be selected). If the process selects highly ranked recipes in this manner but the sum of the user's main ingredient categorization elements is not seven, and if seven recipes are being selected for a week, then the process may iterate, returning to the top of the list of unselected highly ranked recipes and returning to the ratio in the user profile until a set of recommended recipes are selected for the entire week (or other time period in question).

Selection of the sub-set may proceed according to the rank of the recipes, with or without approximation of the ratio(s) determined relative to the user profile.

As illustrated by step 525, the output of the process illustrated in FIG. 5 may be stored in, for example, the user profiles 106, along with a date or date-time field.

FIG. 6 is a flowchart illustrating a process which may be included in the process illustrated in FIG. 2, in which selected recipes are communicated to users. At step 605, if they are not already available, the current recipes for the selected sub-set (containing the recipes to be recommended) are obtained. The current recipes are those which have a date (recorded at step 525) within a specified range or which have a date which has not exceeded a specified expiration date. At step 610, an optional determination may be made regarding whether the selected sub-set are to be emailed to the user. If they are to be emailed, then at optional step 640 an email message containing or linking to a webpage containing the selected sub-set may be composed. This may be accomplished by utilizing the email server 103 or by utilizing the email client 112 (as may be invoked by a webpage executed by the browser 111). At step 645 the composed email message may be sent (if utilizing the email client 112, sending the email may require that the user press the “send” button on the composed email in the email client 112).

At step 615 (which may follow step 610, regardless of whether or not an email message is to be or was sent), the Cozi Server 101, for example through the Recipe Recommender 104, may receive an instruction to create an interface for the selected sub-set. The instruction may come from the system itself (such as that all selected sub-sets are labeled to be displayed in an interface) or may come from a user navigating to a display interface for the selected sub-set. At step 620, the display interface may be created. Creation of the interface may comprise associating the records for the selected sub-set with a pre-existing template for a display interface. A pre-existing display interface template may include graphical objects which display the recipes, information associated with the recipes, and graphical control objects. The user may interact with the graphical control objects; examples of graphical control objects comprise a “drag handle” to allow a recipe to be dragged to another position in the list (for example, to drag a recipe to Thursday), a graphical control object to delete a recipe, a graphical control object to print a recipe or list of recipes, a graphical control object to email the recipe (which may lead to element 640 in FIG. 6), a “thumbs up/down” selector, an “add to Keepers” selector (which may add the recipe to the users list of Keepers), an “add from Keepers” selector (which may add a Keepers recipe to the list), a shopping list selector, a “comment” selector, and a “buy” selector (which may cause the system to purchase and/or have the items delivered to the user—see for example, element 225 of FIG. 2). User interaction with the graphical control objects is discussed elsewhere in this paper, such as in relation to elements 625 et seq. and in relation to FIG. 7. For example, at step 625 an instruction may be received, for example, from a user, to prepare and/or send a shopping list. At step 630, if not already available, the recipes for the selected sub-set and/or in relation to a selection from the selected sub-set (such as if the user only requests a shopping list for a sub-set of the selected sub-set) may be obtained.

At step 635, a shopping list comprising items from the selected sub-set may be formatted. Formatting the shopping list may comprise grouping multiple instances of the same item together (such as if “flour” appears in more than one recipe), combining the amounts of such grouped items together (such as if one recipe called for 2.5 cups and another recipe called for 2 tablespoons, the result might be 2.62 cups), and rounding up to the next reasonable unit or the next unit as sold by a grocery store (the result might be 3 cups or a ½ pound bag, if that is the smallest unit that a grocery store sells). The formatted shopping list may include that if a mouse or similar is floated over the amount, that the separate components adding up to the total amount are shown in a “hint” box. Formatting the shopping list may also include determining that certain items are “staples” or similar, which should not be included in a shopping list or which should be identified separately to the user (such as, “you will need flour”). Formatting the shopping list may comprise associating the items from the selected sub-set with a pre-existing template. The process may then proceed to step 225, where the grocery shopping list may be communicated to the user, to a grocery store for purchase, and/or to a delivery service for delivery to the user. When communicated, the shopping list may include options to allow items to be deleted (such as if the user knows that the user has enough flour). Element 640 indicates returning to step 230 of FIG. 2 (which goes to FIG. 7), showing other examples of receiving user input.

FIG. 7 is a flowchart illustrating a process which may be included in the process illustrated in FIG. 2, in which examples of user input are received and processed. At step 705, the user input is received. The user input may be received from explicit interaction with graphical control objects, such as, for example, discussed in relation to elements 615 and 620. As discussed in relation to such elements, examples of explicit user input may comprise interacting with a graphical control object which allows the user to print a recipe, email a recipe, give a recipe a “thumbs up/down” rating, provide another rating, provide a comment regarding a recipe, delete a recipe from a list, add a recipe to the user's Keepers list, print a shopping list containing items from the recipe, and buy the items in the shopping list. The user input may also be implicit, such as a command not to dim an interface (such as in the Cozi App 116) displaying a recipe. The distinction between explicit and implicit user input is variable, for example, printing a recipe may also be considered implicit user input. Decision step 710 depicts determining whether the user input is explicit or implicit, though this may not be a separate decision and may reflect the source of the user input rather than a decision node. Step 715 is represented as a decision node regarding whether the user input is positive or negative. If the user input is negative, for example, if the user input is a “thumbs down” or “delete recipe” or “I don't like this recipe” indication, then at step 720 additional input may be requested regarding the user input. For example, the user may be requested to identify if the user did not like the main ingredient, the preparatory steps, equipment required to follow the recipe, a seasoning, or a caloric content of the recipe. The user may be provided with a scale or other means to indicate a small or large negative interaction. At step 725 the categorization element may be incremented down (such as by a number, such as a reduction of 0.25, 1, or 5 on a scale of 0 to 9). The user may be allowed to exclude all recipes including a categorization element (such as by setting the user's categorization element for “shellfish” to zero).

At step 730, positive user input was received (which may have been implicit, such as printing a recipe or not dimming a user interface which displayed the recipe). At step 730, the positive user input results in incrementing categorization elements for the user upward (such as by a number, such as an increase of 0.25, 1, or 5 on a scale of 0 to 9). The process may then proceed to step 235 of FIG. 2.

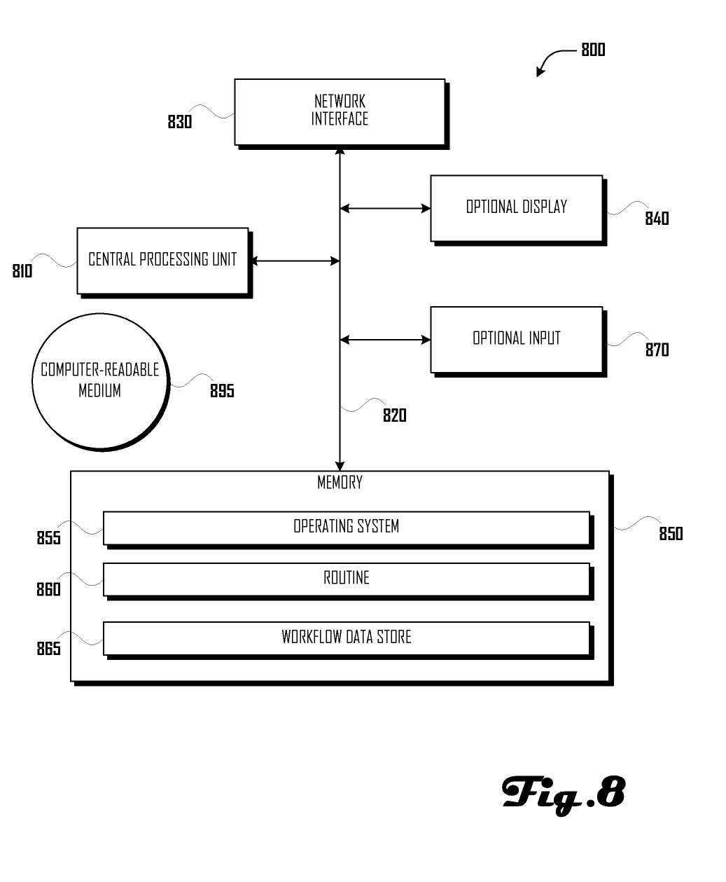

FIG. 8 is a functional block diagram of exemplary computing devices and some data structures and/or components thereof, such as the computing devices shown in FIG. 1. In some embodiments, the computing device 800 may include many more components than those shown in FIG. 8. However, it is not necessary that all of these generally conventional components be shown in order to disclose an illustrative embodiment. As shown in FIG. 8, the computing device 800 includes a network interface 830 for connecting to the network 150.

The computing device 800 also includes at least one processing unit 810, memory 850, and an optional display 840, all interconnected along with the network interface 830 via a bus 820. The memory 850 generally comprises a random access memory (“RAM”), a read only memory (“ROM”), and a permanent mass storage device, such as a disk drive or SDRAM (synchronous dynamic random-access memory). The memory 850 stores program code for routines 860, such as, for example, the Recipe Recommender 104, as well as web browsing applications, web serving applications, email servers and client applications, and database applications. In addition, the memory 850 also stores an operating system 855. These software components may be loaded from a non-transient computer readable storage medium 895 into memory 850 of the computing device 800 using a drive mechanism (not shown) associated with a non-transient computer readable storage medium 895, such as a floppy disc, tape, DVD/CD-ROM drive, memory card, or other like storage medium. In some embodiments, software components may also or instead be loaded via a mechanism other than a drive mechanism and computer readable storage medium 895 (e.g., via network interface 830).

The computing device 800 may also comprise hardware supporting optional input modalities, Optional Input 870, such as, for example, a touchscreen, a keyboard, a mouse, a trackball, a stylus, a microphone, and a camera.

Computing device 800 also comprises or communicates via bus 820 with workflow data store 865. In various embodiments, bus 820 may comprise a storage area network (“SAN”), a high speed serial bus, and/or via other suitable communication technology. In some embodiments, computing device 800 may communicate with workflow data store 865 via network interface 830.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

1. A method of recommending recipes in a computer comprising a memory, the method comprising:
filtering a set of recipes based on constraint criteria;
ranking the filtered recipes relative to a user profile by:
obtaining the values of categorization elements from recipe profiles associated with the filtered recipes, which categorization elements categorize more than one recipe,
obtaining the values of the categorization elements in the user profile, and
determining a ranked score for each of the recipes relative to the user profile utilizing the obtained values;
selecting a sub-set of the ranked recipes based on the determined score; and
communicating the selected sub-set to a user associated with the user profile.

2. The method of claim 1, further comprising saving the selected sub-set in the user profile in association with a date record and communicating the selected sub-set if the date record indicates that the selected sub-set is current.

3. The method of claim 1, wherein determining a ranked score further comprises obtaining a weight assigned to at least one of the categorization elements and wherein determining a score utilizes the obtained values and the weight.

4. The method of claim 1, wherein the selected sub-set comprises recipes for more than one day.

5. The method of claim 2, wherein determining the ranked score comprises:
multiplying the obtained values of the categorization elements from the recipe profile by the corresponding categorization element values in the user profile and by the assigned weight and summing the products thereof.

6. The method of claim 1, wherein the constraint criteria comprise at least one of:
an identifier of or associated with a recipe which identifies the recipe as a Keeper, a categorization element with a zero value in the user profile and which has a non-zero value in at least one of the recipe profiles,
a categorization element associated with a caloric content of a recipe, which caloric categorization element has a value above a threshold, and
an element in a user profile associated with when a recipe was last communicated to the user associated with the user profile.

7. The method of claim 6, wherein filtering comprises determining a categorization element with a zero value in the user profile and removing recipes from the filtered set, which removed recipes have a non-zero value for the categorization element with a zero value in the user profile.

8. The method of claim 7 wherein the categorization element with a zero value in the user profile comprises at least one of categorization elements for a main ingredient of a recipe, a dish type, and cooking equipment required to prepare a recipe.

9. The method of claim 1, wherein the categorization elements comprise at least one of a main ingredient of a recipe, whether a recipe is vegetarian, a dish type, and equipment needed to prepare a recipe.

10. The method of claim 9 wherein the categorization element for a main ingredient of a recipe encodes whether the main ingredient is one of pork, beef, lamb, chicken, turkey, fish, and shellfish.

11. The method of claim 9 wherein the categorization element for a dish type of a recipe encodes whether the dish type is one of a soup, a salad, and a sandwich.

12. The method of claim 5, wherein ranking the recipes further comprises multiplying the determined score by a value for a multiplier for each of the recipes, which multiplier comprises at least one of a multiplier for seasonality, for whether the recipe is featured, and for a rating of the recipe.

13. The method of claim 1, wherein the categorization element values comprise a binary record.

14. The method of claim 1, wherein the categorization element values comprise values ranging from zero to a positive number.

15. The method of claim 13, wherein the positive number is 9.

16. The method of claim 1, wherein selecting a sub-set of the ranked recipes based on the determined score further comprises selecting a sub-set, which sub-set has a ratio of categorization element values of at least one of main ingredient and dish type, which ratio approximates the corresponding ratio in the user profile.

17. The method of claim 1, further comprising receiving a positive or negative user action associated with one of the sub-set of recipes and modifying at least one of values of the categorization elements in the user profile based on the received user action.

18. The method of claim 17 wherein if the received user action is negative, then requesting user input regarding at least one of the categorization elements, receiving user input, and modifying the value of the categorization element based on the user input.

19. The method of claim 17 wherein if the received user action is positive, then increasing the value of categorization elements in the user profile when the corresponding categorization elements in the recipe profile have a positive value.

20. The method of claim 17 wherein the positive action comprises at least one of an instruction to print the recipe, an instruction that the user liked the recipe, an “add to keepers” instruction, an instruction to add the ingredients of the recipe to a shopping list associated with the user, an instruction to email the recipe, and an instruction not to dim the screen display for a portable computing device on which the recipe was being displayed.

21. The method of claim 17 wherein the negative action comprises at least one of an instruction that the user did not like the recipe, an instruction that the user does not want to use the type of cooking required to prepare the recipe, an instruction that the user did not like the main ingredient found in the recipe, and an indication that the recipe was not healthy enough.

22. The method of claim 1, further comprising receiving an instruction from the user to perform at least one of the following: print a recipe in the selected sub-set, prepare a shopping list comprising ingredients associated with recipes in the selected sub-set, communicating the prepared shopping list to the user, remove a recipe from the selected sub-set, add a recipe to the selected sub-set, and move the position of a recipe in the selected sub-set.

23. The method of claim 1, further comprising obtaining a list of ingredients associated with the recipes in the selected sub-set and preparing a shopping list based on the obtained list of ingredients.

24. The method of claim 23, further comprising grouping the same items together and combining the amounts of the items.

25. The method of claim 23, further comprising identifying products which may be purchased to satisfy the amounts.

26. The method of claim 25, wherein identifying products which may be purchased further comprises cross-referencing the items with a list of available items from a grocery store.

27. The method of claim 23, further comprising sending an instruction to a grocery store to purchase the items in the shopping list.

28. The method of claim 1, wherein the user profile is a user profile for a group of people.

29. The method of claim 28, wherein the values of the user profile are determined by a user profile associated with one person from among the group.

30. The method of claim 28, wherein the user profile values of at least a first user is used to filter, rank, and select a first sub-set of recipes for at least one meal and the user profile values of at least a second user is used to filter, rank, and select a second sub-set of recipes for at least a second meal.

31. A computer system with a computer readable medium comprising instructions which, when executed, perform the method according to claim 1.

32. A method of recommending recipes in a computer comprising a memory, the method comprising:
obtaining the recipes which have been ranked highly by a set of users not including a second user;
obtaining the recipes which have been ranked highly by the second user;
determining a best user match between the second user and a first user among the first set of users based on correlations in the recipe rankings;
identifying a first recipe ranked highly by the first user which is not ranked by the second user;
communicating the first recipe to the second user.

33. The method according to claim 32, wherein a recipe is ranked highly if it has been liked by a user.
